(19) United States
(12) Patent Application Publication
(10) Pub. No.: US 2023/0251167 A1
(43) Pub. Date: Aug. 10, 2023

(54) LEARNING DEVICE, DEFECT DETECTION DEVICE, AND DEFECT DETECTION METHOD

(71) Applicant: Mitsubishi Electric Corporation, Tokyo (JP)

(72) Inventor: Yasuhiro TOYAMA, Tokyo (JP)

(73) Assignee: Mitsubishi Electric Corporation, Tokyo (JP)

(21) Appl. No.: 18/299,434

(22) Filed: Apr. 12, 2023

Related U.S. Application Data
(63) Continuation of application No. PCT/JP2020/045745, filed on Dec. 8, 2020.

(51) Int. Cl. G01M 99/00; G06N 20/00

(52) U.S. Cl. CPC G01M 99/005; G06N 20/00

(57) ABSTRACT

A learning device comprising: a training time-series data acquisition unit to collect both training time-series data acquired by a sensor mounted on a target device, and set parameter data of the target device or environment data concerning the target device, while associating the training time-series data with the set parameter data or the environment data; a segment set generation unit to divide the training time-series data into training segments, to generate a segment set containing the training segments; a segment set sort unit to classify the training segments contained in the generated segment set into at least one similar segment set, using either the set parameter data or the environment data; and a sample segment generation unit to generate a sample segment showing a normal region of the operation of the target device from the training segments contained in the at least one similar segment set.

### CROSS REFERENCE TO RELATED APPLICATIONS

This application is a continuation of PCT International Application No. PCT/JP2020/045745, filed on Dec. 8, 2020, all of which is hereby expressly incorporated by reference into the present application.

### TECHNICAL FIELD

The present disclosure relates to a learning device, a defect detection device, and a defect detection method.

### BACKGROUND ART

To monitor the operations of various devices, such as a plant device, a manufacturing device, an elevator, and an air conditioner, it is useful to evaluate the operation of a target device which is a target to be monitored and then detect a defect from data acquired by a sensor mounted on or disposed at in the vicinity of the target device. For example, in Patent Literature 1, a technology of detecting a defect of a target device in the following way is described. First, from test time-series data about the target device are generated multiple segments which are pieces of partial time-series data of the test time-series data. Next, a comparison between the generated segments and segments of past training time-series data is made, and a segment of the test time-series data which is similar to a segment of the past training time-series data is detected. This determination of similarity is performed using the distance between the segments, e.g., the Euclidean distance. Next, a segment of the test time-series data which is least similar to a segment of the training time-series data is detected out of the detected similar segments as a specific point showing that the target device is defective.

### CITATION LIST

### Patent Literature

Patent Literature 1: WO 2016/117086 A

### SUMMARY OF INVENTION

### Technical Problem

A problem with such a technology as disclosed in Patent Literature 1 is that when there is an allowable displacement in a time direction between a segment of the training time-series data and a segment of the test time-series data, it is determined that the segment of the test time-series data is abnormal. More specifically, according to the technology of Patent Literature 1, the similarity between segments is determined using the distance between the segments such as the Euclidean distance, and a problem with the technology is therefore that when data at a time falling within a time width shifted is acquired, the distance at the time is estimated to be large and it is determined that the segments are not similar.

The present disclosure is made in order to solve the above-mentioned problem, and an object of an aspect of embodiments of the present disclosure is to provide a learning device to generate a learning model for determining the similarity of time-series data with a margin in time direction.

### Solution to the Problem

An aspect of a learning device according to this disclosure includes: first processing circuitry to collect both training time-series data acquired by a sensor mounted on a target device same with or similar to a monitor target device or disposed at in the vicinity of the target device, and either set parameter data of the target device or environment data concerning the target device, while associating the training time-series data with the set parameter data or the environment data;

to divide the training time-series data into training segments which are pieces of partial time-series data showing an operation state containing both a rise from a first value to a second value and a fall from the second value to the first value in a waveform represented by the training time-series data, to generate a segment set containing the training segments;

to classify the training segments contained in the generated segment set into at least one similar segment set by grouping similar training segments, using either the set parameter data or the environment data; and

to generate a sample segment showing a normal region of the operation of the target device from the training segments contained in the at least one similar segment set.

### Advantageous Effects of Invention

According to the learning device of the present disclosure, a learning model for determining the similarity of time-series data with a margin in time direction can be generated.

### BRIEF DESCRIPTION OF DRAWINGS

FIG. 1 is a block diagram showing an example of the configuration of a defect detection system;

FIG. 2 is a view showing an example of a sensor data table;

FIG. 3A is a view showing an example of the generation of a sample segment;

FIG. 3B is a view showing the example of the generation of a sample segment;

FIG. 4A is a block diagram showing an example of the hardware configuration of the defect detection system;

FIG. 4B is a block diagram showing another example of the hardware configuration of the defect detection system;

FIG. 5 is a flowchart showing the operation of the defect detection system;

FIGS. 6A to 6C are views showing an advantageous effect of a defect detection device or the defect detection system;

FIG. 6A is a view showing a waveform at the time of a normal operation;

FIGS. 6A to 6C are views showing an advantageous effect of the defect detection device or the defect detection system;

FIG. 6B is a view showing a waveform of an operation in an operation example 1 different from the time of the normal operation;

FIGS. 6A to 6C are views showing an advantageous effect of the defect detection device or the defect detection system; and

FIG. 6C is a view showing a waveform of an operation in an operation example 2 different from the time of the normal operation.

### DESCRIPTION OF EMBODIMENTS

Hereinafter, various embodiments according to the present disclosure will be explained in detail while referring to the drawings. It is assumed that the components denoted by the same reference sign in the whole of the drawings have the same configuration or a similar configuration, or the same function or a similar function.

### Embodiment 1

### <Configuration>

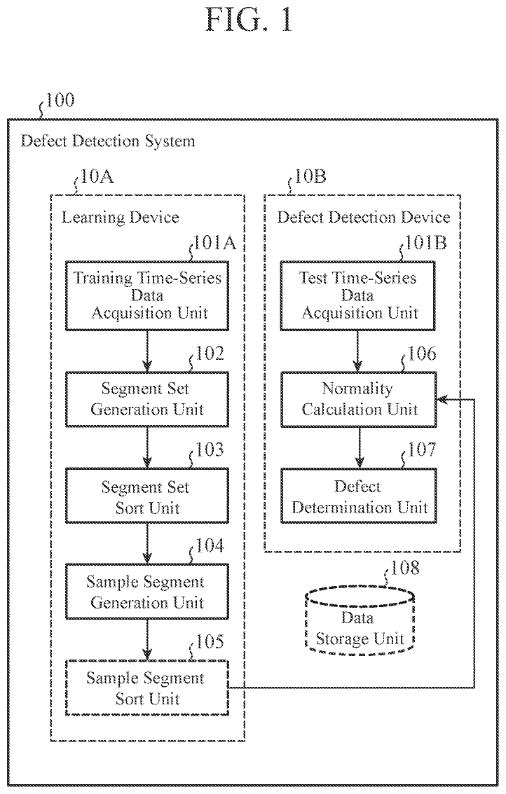

FIG. 1 is an example of the configuration of a defect detection system 100 according to Embodiment 1 of the present disclosure. The defect detection system 100 includes a learning device 10A, a defect detection device 10B, and a data storage unit 108. The learning device 10A includes a training time-series data acquisition unit 101A, a segment set generation unit 102, a segment set sort unit 103, a sample segment generation unit 104, and a sample segment sort unit 105. In a learning phase, the learning device 10A constructs a learning model on the basis of training time-series data.

The defect detection device 10B includes a test time-series data acquisition unit 101B, a degree-of-normality calculation unit 106, and a defect determination unit 107. In a detection phase, the defect detection device 10B determines whether or not test time-series data is defective.

A not-illustrated common time-series data acquisition unit may be provided instead of the training time-series data acquisition unit 101A and the test time-series data acquisition unit 101B which are provided separately.

### <Learning Phase>

The training time-series data acquisition unit 101A acquires time-series data concerning a device (simply referred to as a “target device” hereinafter) which is same with or similar to a target device which is a target to be monitored, as training time-series data. Examples of the acquired time-series data include sensor data acquired by a not-illustrated sensor mounted on or disposed at in the vicinity of the target device, set parameter data set to the target device, and environment data acquired by a not-illustrated sensor provided in space where the target device is placed. The training time-series data acquisition unit 101A collects the sensor data, the set parameter data, and the environment data via a not-illustrated network.

The sensor data is time-series data concerning the operation of the target device. For example, in a case where the target device is a manufacturing device having a motor, examples of the sensor data include the temperature, the vibration, the rotation speed, the contact current, and the contact voltage of the motor.

The set parameter data is time-series data concerning parameters which are set in order to cause the target device to operate. For example, in a case where the target device is a manufacturing device having a motor, examples of the set parameter data include a current set value for causing the motor to operate and a voltage set value for causing the motor to operate.

The environment data is time-series data concerning the environment surrounding the target device. For example, in a case where the target device is a manufacturing device having a motor, examples of the environment data include the temperature and the humidity of indoor space where the manufacturing device is placed.

Although in FIG. 1 an arrow is extended from the training time-series data acquisition unit 101A to the segment set generation unit 102 in order to show a general flow of data, the training time-series data acquisition unit 101A provides the collected various pieces of data to the data storage unit 108. After that, the segment set generation unit 102 refers to the pieces of data stored in the data storage unit 108 and performs predetermined processing. Likewise, arrows between the other functional units and the data storage unit 108 are omitted in FIG. 1 in order to show a general flow similarly.

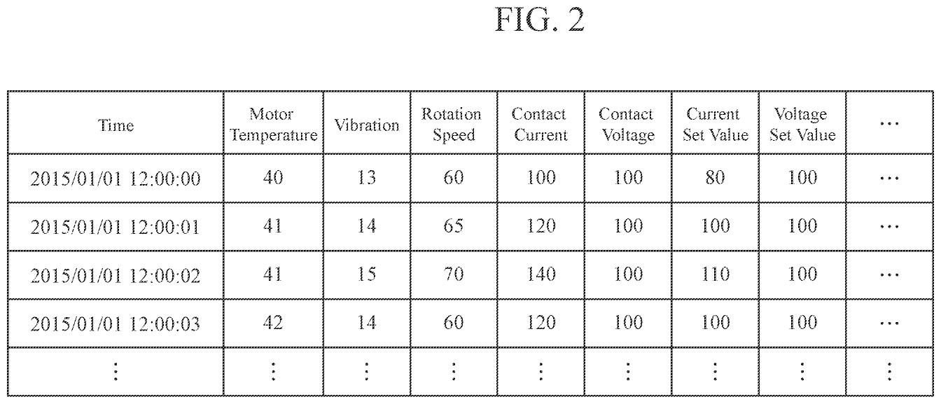

The data storage unit 108 stores the various pieces of data in a data table format as shown in, for example, FIG. 2. In FIG. 2, the motor temperature, the vibration, the rotation speed, the contact current, the contact voltage, the current set value, and the voltage set value are shown as an example of data items. The data items are set up as appropriate in accordance with the pieces of data to be collected. In FIG. 2, the time-series data about each data item is recorded every second. The pieces of data concerning a single target device may be divided into multiple tables as long as a correspondence can be established between the target device and the data items. Data items common among multiple target devices, such as the air temperature and the humidity, may be managed using a common table other than the data table of each of the target devices.

The segment set generation unit 102 divides the training time-series data into multiple training segments, to generate a segment set which is a set containing the multiple training segments. The training time-series data is acquired from the data storage unit 108. In the present disclosure, a segment means a part of the time-series data, the part showing an operation state which contains both a rise from a first value to a second value and a fall from the second value to the first value in the waveform shown by the time-series data. Each of the first and second values may be a specific value, or may be an arbitrary value falling within a predetermined region from a certain value. Each of the first and second values is a value in a steady state. As an example of the division, in a case of a manufacturing device which repeatedly produces the same product, training time-series data within a time period during which one product is produced is defined as one segment. As another example, in a case where manufacturing of one product includes multiple processes or operations, the training time-series data about each process or operation is defined as one segment. As a further example, in a case where no clear repetition of the same operation is performed, such as in a case of a power generation plant, the training time-series data about each operation, such as a start-up operation, a constant output operation, an output fluctuation operation, or a stop operation, is defined as one segment. When a single operation, such as a constant output operation of a power generation plant, continues over a long time, the training time-series data about the operation may be further divided into pieces of data, each having a constant time width, and the training time-series data about each of the sections after divided in this way may be defined as one segment. A dividing method is set up by, for example, a user of the defect detection system 100. The segment set generation unit 102 provides the segment set generated thereby to the segment set sort unit 103. The dividing method is stored in the data storage unit 108 so that the degree-of-normality calculation unit 106 can refer to the dividing method later on.

The segment set sort unit 103 classifies the segment set generated by the segment set generation unit 102 into one or more similar segment sets by grouping training segments having a similar tendency into one set. As an index used for the classification, for example, the set parameter data of the target device may be used. For example, because a manufacturing device performs the same operation as long as the set parameter data is the same, the training segments contained in the segment set can be classified into similar segment sets, each having the same set parameter data. In a case where it is provided as preliminary knowledge that an external factor such as the air temperature or the humidity other than the set parameter data exerts an influence upon the operation of the target device, the classification may be performed also in consideration of the external factor. For example, the training segments may be classified according to training segment having both the same set parameter data and the same external factor. Furthermore, the training segments may be classified into sets using, as another index, similarity in the tendency of sensor data. In this case, sensor data used for the classification is specified, a comparison among the pieces of sensor data about the training segments is performed, the Euclidean distances among the training segments are calculated, and the training segments are classified into sets of training segments having a close distance therebetween. Instead of the Euclidean distances, other distances, such as Mahalanobis' distances or Dynamic Time Warping distances, may be used. The segment set sort unit 103 furnishes the one or more similar segment sets after the classification to the sample segment generation unit 104. The method used for the classification is stored in the data storage unit 108 so that the degree-of-normality calculation unit 106 can refer to the method later on.

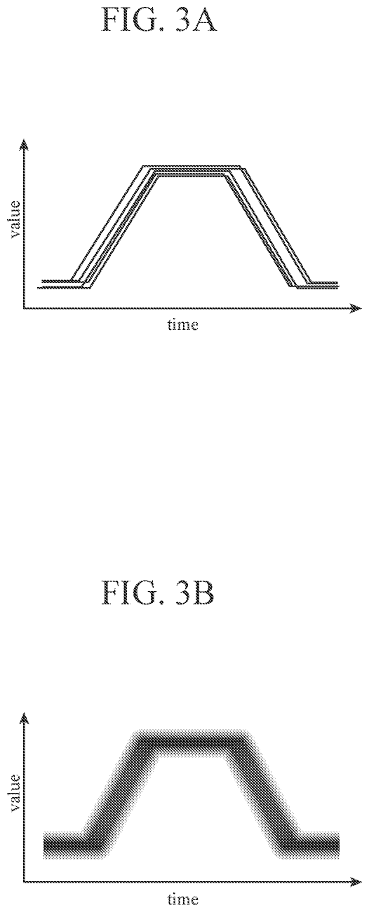

The sample segment generation unit 104 generates, as to each similar segment set, a sample segment which is a segment showing a normal region used at the time of defect detection, using the various pieces of data about the similar segment set. An example of the generation of a sample segment is shown in FIGS. 3A and 3B.

FIG. 3A is a view of display of the multiple training segments contained in a similar segment set, the display being obtained by superimposing the multiple training segments with the start times of the training segments being synchronized in terms of a certain data item (e.g., the rotation speed). The left end of the data shows the start time of each of the training segments. The horizontal axis and the vertical axis of this FIG. 3A are normalized, so that their scales are equivalent. As a normalizing method, z normalization or min-max normalization can be used. In a case of using z normalization, as to each of the horizontal and vertical axes of FIG. 3A, a standardizing operation of subtracting the average of all the data from each data and then performing division by a standard deviation in such a way that the distribution of all the data has an average of 0 and a variance of 1 is performed. In a case of using min-max normalization, as to each of the horizontal and vertical axes (time and numeric value axes) of FIG. 3A, an operation of subtracting the minimum of all the data from each data and then performing division by the maximum obtained after the subtraction in such a way that the distribution of all the data has a minimum of 0 and a maximum of 1 is performed. Because the statistical values used at the time of normalization and including the average, the standard deviation, the minimum, and the maximum are used by the degree-of-normality calculation unit 106 later on, the statistical values are stored in the data storage unit 108.

The sample segment generation unit 104 determines the normal region using the normalized data of FIG. 3A. The normal region is expressed using, for example, the probability distribution of existence probabilities of the data at each normalization time on the graph. An example of expressing a difference in degree of the existence probabilities on a gray scale is shown in FIG. 3B. For example, in a case where there is a tendency that at each normalization time of FIG. 3B, normalized training segments are most highly concentrated at the average of all the normalized training segments, and the normalized training segment distribution decreases with distance from the average, the closer they are to the average of all the normalization training segments, the higher existence probability they have and hence the deeper color they have, while the further they are from the average, the lighter color they have, in FIG. 3B. As a method of calculating the data existence probabilities, for example, a kernel density distribution based on a Gaussian kernel can be used. As another method, the k-nearest neighbors algorithm may be used. The sample segment generation unit 104 generates a sample segment showing the normal region for each similar segment set as a learning model in this way. As a result, the sample segment generation unit 104 generates a sample segment set including multiple sample segments. The sample segment generation unit 104 stores the sample segments generated thereby (learning model) in the data storage unit 108.

The sample segment sort unit 105 is an arbitrary configuration unit for improving the speed of a search performed by the degree-of-normality calculation unit 106. More specifically, the sample segment sort unit 105 is optional. In order to improve the speed of a search performed by the degree-of-normality calculation unit 106, the sample segment sort unit 105 sorts the multiple sample segments (learning model) using various pieces of data. For example, the multiple sample segments are sorted in descending order of the value of data about a certain data item. The sample segment sort unit 105 stores a sorted result in the data storage unit 108.

### <Detection Phase>

The test time-series data acquisition unit 101B acquires the time-series data concerning the monitor target device which is a target to be monitored, as test time-series data, like the training time-series data acquisition unit 101A. The test time-series data may be collected while being associated with either the set parameter data of the monitor target device or the environment data concerning the monitor target device. The association of the test time-series data with either the set parameter data or the environment data makes it possible to search for a sample segment generated from the training segment associated with either the set parameter data or the environment data which is the same as either the set parameter data or the environment data associated with the test time-series data.

The degree-of-normality calculation unit 106 calculates the degree of normality of the test time-series data using the sample segments (learning model) which are generated by the sample segment generation unit 104 or which are sorted by the sample segment sort unit 105. In order to calculate the degree of normality, the degree-of-normality calculation unit 106 performs the following processing.

The degree-of-normality calculation unit 106 generates one or more test segments by dividing the test time-series data acquired by the test time-series data acquisition unit 101B using the same method as that used by the segment set generation unit 102. The degree-of-normality calculation unit 106 acquires the dividing method used by the segment set generation unit 102 by referring to the data storage unit 108.

The degree-of-normality calculation unit 106 performs a search for a similar segment set which has a tendency similar to that of a test segment generated thereby. In order to perform this search, the degree-of-normality calculation unit 106 acquires the method which the segment set sort unit 103 has used for the classification by referring to the data storage unit 108. When a similar segment set having a tendency similar to that of the generated test segment is found, the degree-of-normality calculation unit 106 determines that the generated test segment belongs to the found similar segment set.

The degree-of-normality calculation unit 106 normalizes the test segment which is determined to belong to which similar segment set into a normalized test segment. This normalization is performed by the degree-of-normality calculation unit 106's referring to the data storage unit 108, acquiring the method which is used for the normalization by the sample segment generation unit 104, and using the same method.

The degree-of-normality calculation unit 106 extracts the learning model which is generated by the sample segment generation unit 104 from the similar segment set to which the normalized test segment belongs, or which is sorted by the sample segment sort unit 105. Then, the degree-of-normality calculation unit 106 calculates the existence probability which is the probability or degree of the normalized test segment being contained in the normal region at each normalization time of the extracted learning model when the normalized test segment is plotted on the extracted learning model. The degree-of-normality calculation unit 106 outputs this existence probability calculated thereby as the degree of normality of the test segment, and the outputted degree of normality is stored in the data storage unit 108.

The defect determination unit 107 determines whether or not the test segment of the test time-series data is defective on the basis of data about the degree of normality calculated by the degree-of-normality calculation unit 106. A preset threshold is used for the determination of whether or not the test segment is defective. For example, the percentage of defective data contained or assumed to be contained in the training time-series data is defined as the threshold. More concretely, in a case where all the training time-series data are assumed to be normal, the threshold is set to 0 (%), and it is determined that the test segment is defective when the test segment has a time when the degree of normality of the test segment is 0%. Similarly, in a case where there is a possibility that nearly 5% of the training time-series data are defective, the threshold is set to 5 (%), and it is determined that the test segment is defective when the test segment has a time when the degree of normality of the test segment is 5%. As another example, in a case where it is desired that a case in which the test segment does not have a time when the degree of normality is particularly small, but the degree of normality of the test segment is low as a whole is determined to be defective, the threshold is set to 5 (%), and it is determined that the test segment is defective when the average of the degree of normality of the test segment is less than 5%. The defect determination unit 107 outputs the determination result to a predetermined device such as a not-illustrated display device. The data about the degree of normality may also be outputted together with the determination result.

Although in the above explanation, the configuration in which the defect detection system 100 includes the data storage unit 108 is explained, the defect detection system is not limited to the one having this configuration. One or more not-illustrated network storage devices arranged on a not-illustrated communication network, instead of the data storage unit 108, may store the various pieces of data and the sample segments (learning model), and either the degree-of-normality calculation unit 106 or the defect determination unit 107 may be configured in such a way as to access a network storage device.

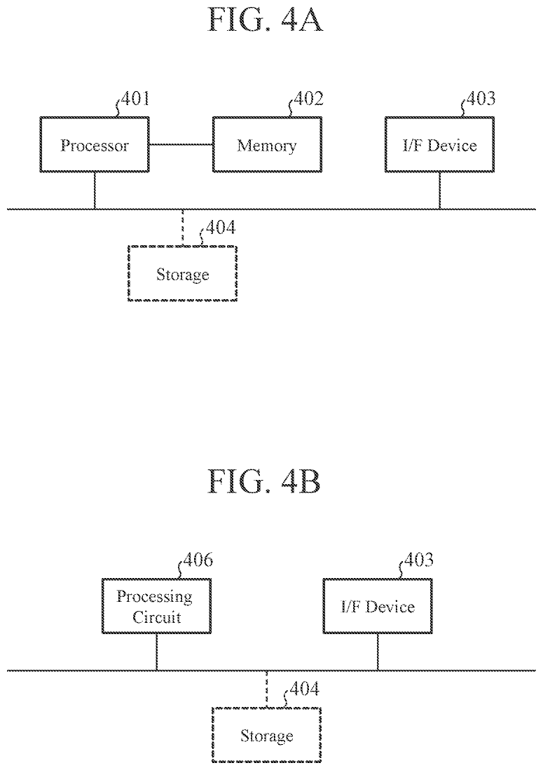

Next, an example of the hardware configuration of the defect detection system 100 will be explained by referring to FIGS. 4A and 4B. As an example, the defect detection system 100 includes a processor 401, a memory 402 connected to the processor 401, an I/F device 403, and a storage 404, as shown in FIG. 4A. The storage 404 is an optional component unit. The processor 401, the I/F device 403, and the storage 404 are connected to one another via a bus. The training time-series data acquisition unit 101A and the test time-series data acquisition unit 101B are implemented by the I/F device 403. Further, the segment set generation unit 102, the segment set sort unit 103, the sample segment generation unit 104, the sample segment sort unit 105, the degree-of-normality calculation unit 106, and the defect determination unit 107 are implemented by the processor 401's reading and executing a program stored in the memory 402. Further, the data storage unit 108 is implemented by the storage 404. The program is implemented as software, firmware, or a combination of software and firmware. As an example of the memory 402, for example, a non-volatile or volatile semiconductor memory, such as a random access memory (RAM), a read only memory (ROM), a flash memory, an erasable programmable read only memory (EPROM), or an electrically-EPROM (EEPROM), a magnetic disc, a flexible disc, an optical disc, a compact disc, a mini disc, or a DVD is included.

As another example, the defect detection system 100 includes a processing circuit 406, instead of the processor 401 and the memory 402, as shown in FIG. 4B. In this case, the segment set generation unit 102, the segment set sort unit 103, the sample segment generation unit 104, the sample segment sort unit 105, the degree-of-normality calculation unit 106, and the defect determination unit 107 are implemented by the processing circuit 406. The processing circuit 406 is, for example, a single circuit, a composite circuit, a programmable processor, a parallel programmable processor, an application specific integrated circuit (ASIC), a field-programmable gate array (FPGA), or a combination of these circuits. The functions of the segment set generation unit 102, the segment set sort unit 103, the sample segment generation unit 104, the sample segment sort unit 105, the degree-of-normality calculation unit 106, and the defect determination unit 107 may be implemented by separate processing circuits, or those functions may be implemented collectively by a single processing circuit.

The pieces of data stored in the data storage unit 108 are stored in the storage 404. In a case where the defect detection system 100 is connected to an external device, such as a not-illustrated data server, by way of the I/F device 403, the pieces of data may be transmitted to the external device via the I/F device 403, instead of being stored in the storage 404. In the case where the defect detection system 100 is connected to the external device in this way, the defect detection system 100 does not need to include the storage 404. A result of an intermediate process, out of the processes performed by the segment set generation unit 102, the segment set sort unit 103, the sample segment generation unit 104, the sample segment sort unit 105, the degree-of-normality calculation unit 106, and the defect determination unit 107, is stored temporarily in the memory 402, the intermediate process result being not stored in the storage 404. The determination result provided by the defect determination unit 107 is outputted by a not-illustrated output device such as a display device via the I/F device 403, as needed.

### <Operation>

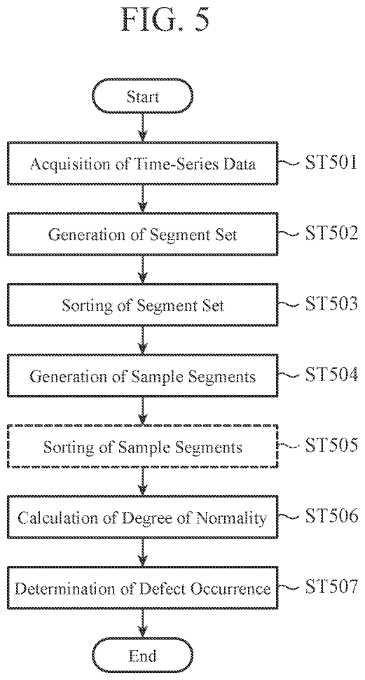

Next, the operation of the defect detection system 100 will be explained by referring to a flowchart of FIG. 5.

In step ST501, the time-series data acquisition unit 101 acquires the time-series data as either training time-series data or test time-series data. In the case of acquiring the time-series data as training time-series data, the training time-series data is collected while being associated with either the set parameter data of the target device or the environment data concerning the target device. In the case of acquiring the time-series data as test time-series data, the test time-series data may be collected while being associated with either the set parameter data of the target device or the environment data concerning the target device.

In step ST502, the segment set generation unit 102 divides the training time-series data into multiple training segments, and generates a segment set which is a set containing the multiple training segments.

In step ST503, the segment set sort unit 103 classifies the generated segment set into one or more similar segment sets by grouping training segments having a similar tendency into one set. The determination of whether training segments have a similar tendency is performed using, for example, the set parameter data or the environment data.

In step ST504, as to the one or more similar segment sets, the sample segment generation unit 104 normalizes the training segments contained in the one or more similar segment sets, and generates sample segments (learning model) which are segments each showing a normal region used at the time of defect detection, by using the various pieces of data about the normalized training segments.

In step ST505, the sample segment sort unit 105 sorts the sample segments (learning model) using the various pieces of data. Because step ST505 is an optional step, this step may be omitted.

In step ST506, the degree-of-normality calculation unit 106 calculates the degree of normality of a test segment of the test time-series data acquired in step ST501, using the sample segments (learning model) which are generated by the sample segment generation unit 104 or which are sorted by the sample segment sort unit 105. At that time, in step ST502, the degree-of-normality calculation unit 106 generates the test segment of the test time-series data using the same method as that which the segment set generation unit 102 has used for the segmentation of the training time-series data. The degree-of-normality calculation unit 106 also searches for a similar segment set which has a tendency similar to that of the test segment using the same method as that which the segment set sort unit 103 has used for the classification in step ST503. Further, in step ST504, the degree-of-normality calculation unit 106 normalizes the test segment on which the determination of to which similar segment set the test segment belongs is performed, using the same method as that which the sample segment generation unit 104 has used for the normalization. Next, the degree-of-normality calculation unit 106 extracts the learning model generated from the similar segment set to which the normalized test segment belongs. Then, the degree-of-normality calculation unit 106 calculates the existence probability which is the probability that the normalized test segment is contained in the normal region at each normalization time of the extracted learning model when the normalized test segment is plotted on the learning model. The degree-of-normality calculation unit 106 outputs this calculated existence probability as the degree of normality of the test segment.

In step ST507, the defect determination unit 107 determines whether or not the test segment is defective using the degree of normality of the test segment.

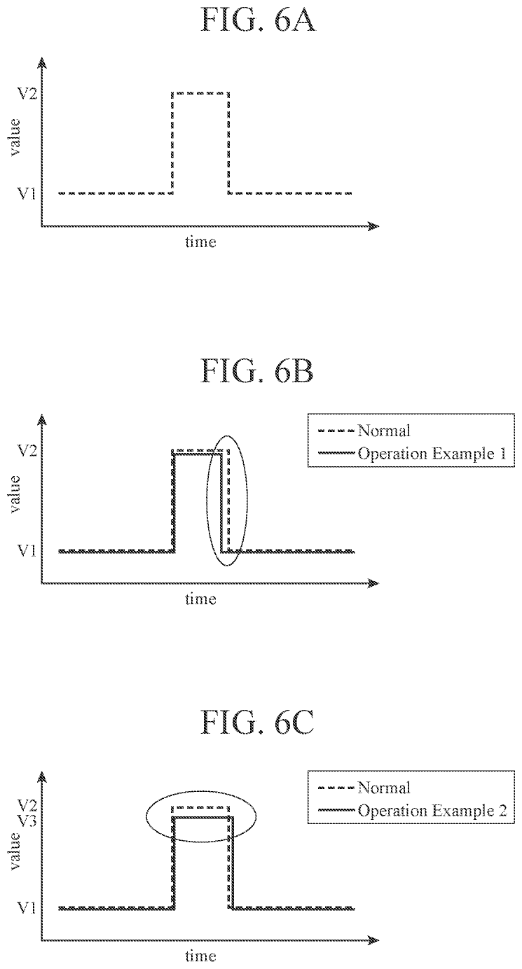

Next, an advantageous effect of the defect detection system 100 will be explained by referring to FIGS. 6A to 6C. FIG. 6A is a view showing one piece of segment data with a broken line, the segment data being at the time of a normal operation of either the target device or a device which is similar to the target device. An operation in which, in the waveform of FIG. 6A, an initial value (first value v1) lasts during a certain time duration, the waveform rises after that, a value (second value v2) after the rise lasts during a certain time duration, the waveform falls after that, and the waveform returns to the initial value (first value v1) is shown.

FIG. 6B is a view showing an operation according to operation example 1 different from the operation example at the time of normal operation of the device as shown in FIG. 6A, the operation examples belonging to the same similar segment set. In FIG. 6B, the waveform of the device, the waveform exhibiting the operation in the operation example 1, is shown by a solid line, and the waveform at the time of the normal operation of FIG. 6A is superimposed and displayed by a broken line. In the waveform of FIG. 6B, the initial value (first value v1) lasts during a certain time duration, the waveform rises after that, and the value (second value v2) after the rise lasts during a certain time duration, but the value after the rise lasts only during a shorter time duration than that at the time of the normal operation of FIG. 6A.

FIG. 6C is a view showing an operation according to operation example 2 different from the operation example at the time of normal operation of the device as shown in FIG. 6A, the operation examples belonging to the same similar segment set. In FIG. 6C, the waveform of the device, the waveform exhibiting the operation in the operation example 2, is shown by a solid line, and the waveform at the time of the normal operation of FIG. 6A is superimposed and displayed by a broken line. In the waveform of FIG. 6C, the initial value (first value v1) lasts during a certain time duration, the waveform rises after that, and the value after the rise lasts during a certain time duration, but the value after the rise is one (third value v3) smaller than that at the time of the normal operation of FIG. 6A.

Any one of the examples of FIGS. 6B and 6C is one in which a similar degree of deviation appears with respect to the specifications of the target device. Therefore, it is desirable that the final determination of whether a defect has occurred is the same in both of the cases of FIGS. 6B and 6C. More specifically, it is desirable that as long as it is evaluated that the operation in the operation example 1 of FIG. 6B falls within an allowable range, it is evaluated that the operation in the operation example 2 of FIG. 6C also falls within the allowable range. On the contrary, it is desirable that as long as it is evaluated that the operation in the operation example 1 of FIG. 6B is defective, it is evaluated that the operation in the operation example 2 of FIG. 6C is also defective.

However, when a conventional technology of finely dividing a segment as shown in FIG. 6A into parts using a slide window, and performing a defect determination on the basis of distances such as Euclidean distances is used, there occurs a case where the result of the final determination of whether a defect has occurred differs between the cases of FIGS. 6B and 6C. According to the conventional technology, the distance between a data value at a certain time and a data value at the time in question is evaluated, and the determination of whether a defect has occurred is performed. Therefore, as to the example of FIG. 6C, the difference between the value (v2) after the rise at the time of the normal operation and the value (v3) after the rise in the operation example 2 is calculated as the distance. Similarly, as to the example of FIG. 6B, in a case where the time of acquisition of data with the slide window is located in a portion (portion enclosed by a broken line) where there is a displacement between the waveform at the time of the normal operation and the waveform in the operation example 1, the difference between the value (v2) after the rise at the time of the normal operation and the value (first value v1) after the fall in the operation example 1 is calculated as the distance. Thus, according to the conventional technology, the distance calculated as to the example of FIG. 6B is large compared with the distance calculated as to the example of FIG. 6C. Therefore, according to the conventional technology, it is determined that because the example of FIG. 6C falls within the allowable range, the example is not defective, while it is determined that because the example of FIG. 6B does not fall within the allowable range, the example is defective.

In contrast with such a conventional technology as above, according to the embodiments in the present disclosure, data about a waveform having a time duration longer than those in conventional technologies is handled as a whole by regarding an operation state containing both a rise and a fall of the waveform as a segment. Therefore, in consideration of not only a displacement in a value direction but also a displacement in a time direction, a sample segment (learning model) can be generated. Because a test segment is provided using such a sample segment, not only a displacement in the value direction which the test segment has, but also a displacement in the time direction which the test segment has can be evaluated with a margin in time direction. Therefore, according to the embodiments of the present disclosure, it becomes possible to perform defect detection with a higher degree of accuracy than those in conventional technologies.

### <Additional Remarks>

Some aspects of the various embodiments explained above will be summarized below.

### <Additional Remark 1>

A learning device (10A) of Additional Remark 1 includes: a training time-series data acquisition unit (101A) to collect both training time-series data acquired by a sensor mounted on a target device same with or similar to a monitor target device or disposed at in the vicinity of the target device, and either set parameter data of the target device or environment data concerning the target device, while associating the training time-series data with the set parameter data or the environment data; a segment set generation unit (102) to divide the training time-series data into training segments which are pieces of partial time-series data showing an operation state containing both a rise from a first value to a second value and a fall from the second value to the first value in a waveform represented by the training time-series data, to generate a segment set containing the training segments; a segment set sort unit (103) to classify the training segments contained in the generated segment set into at least one similar segment set by grouping similar training segments, using either the set parameter data or the environment data; and a sample segment generation unit (104) to generate a sample segment showing a normal region of the operation of the target device from the training segments contained in the at least one similar segment set.

### <Additional Remark 2>

A learning device of Additional Remark 2 is the one of Additional Remark 1, wherein the at least one similar segment set comprises two or more similar segment sets, the sample segment generation unit (104) generates a sample segment for each of the two or more similar segment sets, and the learning device further comprises a sample segment sort unit (105) to sort the generated sample segments.

### <Additional Remark 3>

A defect detection device (10B) of Additional Remark 3 detects whether or not a monitor target device which is a target to be monitored is defective, wherein the defect detection device includes: a test time-series data acquisition unit (101B) to collect test time-series data acquired by a sensor mounted on the monitor target device or disposed at in the vicinity of the monitor target device; a degree-of-normality calculation unit (106) to generate a test segment from the test time-series data, the test segment being partial time-series data showing an operation state containing both a rise from a first value to a second value and a fall from the second value to the first value in a waveform represented by the test time-series data, to refer to a related sample segment from the one or more sample segments generated by the learning device of Additional Remark 1 or 2, and to calculate a degree of normality showing the degree to which the generated test segment is contained in the normal region of the sample segment which is referred to; and a defect determination unit (107) to determine whether or not the monitor target device is defective on a basis of the calculated degree of normality.

### <Additional Remark 4>

The defect detection device of Additional Remark 4 is the one of Additional Remark 3, wherein the test time-series data acquisition unit collects the test time-series data while associating the test time-series data with either set parameter data of the monitor target device or environment data concerning the monitor target device, and the related sample segment is generated from the training segment associated with either the same set parameter data as that associated with the test time-series data or the same environment data as that associated with the test time-series data.

### <Additional Remark 5>

A defect detection method of Additional Remark 5 includes the steps of:

collecting both training time-series data acquired by a sensor mounted on a target device same with or similar to a monitor target device or disposed at in the vicinity of the target device, and either set parameter data of the target device or environment data concerning the target device, while associating the training time-series data with the set parameter data or the environment data (ST501);

dividing the training time-series data into training segments which are pieces of partial time-series data showing an operation state containing both a rise from a first value to a second value and a fall from the second value to the first value in a waveform represented by the training time-series data, to generate a segment set containing the training segments (ST502);

classifying the training segments contained in the generated segment set into at least one similar segment set by grouping similar training segments, using either the set parameter data or the environment data (ST503);

generating a sample segment showing a normal region of the operation of the target device from the training segments contained in the at least one similar segment set (ST504);

collecting test time-series data acquired by a sensor mounted on the monitor target device or disposed at in the vicinity of the monitor target device;

generating a test segment from the test time-series data, the test segment being partial time-series data showing the operation state, and calculating a degree of normality of the test segment by referring to the generated sample segment (ST506); and

determining whether or not the monitor target device is defective on a basis of the calculated degree of normality (ST507).

Embodiments can be combined, and each of the embodiments can be modified or omitted as appropriate.

### INDUSTRIAL APPLICABILITY

As one use of the learning device 10A of the present disclosure, the defect detection device 10B of the present disclosure, or the defect detection system 100 of the present disclosure, there is a use to a device, such as a manufacturing device, which repeatedly performs the same operation. A manufacturing device that repeatedly produces an same with product often repeats the same operation as long as its setting values are the same. It is judged that there is a possibility that a defect has occurred if there is a different operation among the repetitive operations which the manufacturing device has performed multiple times. When a different operation is performed, a tendency which is different from that at other times of the normal operation may appear in data of a sensor mounted in the device. It is possible to detect an operation having a possibility that a defect has occurred by detecting the different tendency. Because a defective operation may result in defects of products, it is possible to contribute to an improvement in the yield of products by performing maintenance on the device which has performed a defective operation.

As one use of the learning device 10A of the present disclosure, the defect detection device 10B of the present disclosure, or the defect detection system 100 of the present disclosure, there is a use to a device or equipment, such as a power generation plant, which performs a similar operation multiple times or continues the same operation. For example, at the time of a certain operation of the device, such as a start operation, a stop operation, or an output change operation, the operation follows the same sequence and sensor data exhibits a similar tendency in many cases as long as the setting values of the device are the same or the external environment is the same. Therefore, it is judged that there is a possibility that a defect has occurred if there is a different operation among multiple times of operations in which the setting values of the device are the same or the external environment is the same. Further, at the time of a steady operation, there are many cases in which any sensor data always exhibits a similar tendency during a time period when the steady operation is performed as long as the setting values of the device are the same or the external environment is the same. Therefore, it is judged that there is a possibility that a defect has occurred if the time period contains a time or time interval when a different operation is performed. When a different operation is performed, a tendency which is different from that at other times of the normal operation may appear in sensor data of a sensor mounted in the device. It is possible to detect an operation having a possibility that a defect has occurred by detecting the different tendency. Because a defective operation may result in an unexpected operation, it is possible to prevent an unexpected operation by performing maintenance on the device which has performed a defective operation.

### REFERENCE SIGNS LIST

10A: learning device, 10B: defect detection device, 100: defect detection system, 101A: training time-series data acquisition unit, 101B: test time-series data acquisition unit, 102: segment set generation unit, 103: segment set sort unit, 104: sample segment generation unit, 105: sample segment sort unit, 106: degree-of-normality calculation unit, 107: defect determination unit, 108: data storage unit, 401: processor, 402: memory, 403: I/F device, 404 storage, and 406: processing circuit.

1. A learning device comprising:
first processing circuitry
to collect both training time-series data acquired by a sensor mounted on a target device same with or similar to a monitor target device or disposed at in the vicinity of the target device, and either set parameter data of the target device or environment data concerning the target device, while associating the training time-series data with the set parameter data or the environment data;
to divide the training time-series data into training segments which are pieces of partial time-series data showing an operation state containing both a rise from a first value to a second value and a fall from the second value to the first value in a waveform represented by the training time-series data, to generate a segment set containing the training segments;
to classify the training segments contained in the generated segment set into at least one similar segment set by grouping similar training segments, using either the set parameter data or the environment data; and
to generate a sample segment showing a normal region of the operation of the target device from the training segments contained in the at least one similar segment set.

2. The learning device according to claim 1, wherein
the at least one similar segment set comprises two or more similar segment sets,
the first processing circuitry generates a sample segment for each of the two or more similar segment sets, and
the first processing circuitry is further configured to sort the generated sample segments.

3. A defect detection device for detecting whether or not a monitor target device which is a target to be monitored is defective, the defect detection device comprising:
second processing circuitry
to collect test time-series data acquired by a sensor mounted on the monitor target device or disposed at in the vicinity of the monitor target device;
to generate a test segment from the test time-series data, the test segment being partial time-series data showing an operation state containing both a rise from a first value to a second value and a fall from the second value to the first value in a waveform represented by the test time-series data, to refer to a related sample segment from the one or more sample segments generated by the learning device according to claim 1, and to calculate a degree of normality showing the degree to which the generated test segment is contained in the normal region of the sample segment which is referred to; and
to determine whether or not the monitor target device is defective on a basis of the calculated degree of normality.

4. The defect detection device according to claim 3, wherein
the second processing circuitry collects the test time-series data while associating the test time-series data with either set parameter data of the monitor target device or environment data concerning the monitor target device, and
the related sample segment is generated from the training segment associated with either the same set parameter data as that associated with the test time-series data or the same environment data as that associated with the test time-series data.

5. A defect detection device for detecting whether or not a monitor target device which is a target to be monitored is defective, the defect detection device comprising:
second processing circuitry
to collect test time-series data acquired by a sensor mounted on the monitor target device or disposed at in the vicinity of the monitor target device;
to generate a test segment from the test time-series data, the test segment being partial time-series data showing an operation state containing both a rise from a first value to a second value and a fall from the second value to the first value in a waveform represented by the test time-series data, to refer to a related sample segment from the one or more sample segments generated by the learning device according to claim 2, and to calculate a degree of normality showing the degree to which the generated test segment is contained in the normal region of the sample segment which is referred to; and
to determine whether or not the monitor target device is defective on a basis of the calculated degree of normality.

6. The defect detection device according to claim 5, wherein
the second processing circuitry collects the test time-series data while associating the test time-series data with either set parameter data of the monitor target device or environment data concerning the monitor target device, and
the related sample segment is generated from the training segment associated with either the same set parameter data as that associated with the test time-series data or the same environment data as that associated with the test time-series data.

7. A defect detection method comprising:
collecting both training time-series data acquired by a sensor mounted on a target device same with or similar to a monitor target device or disposed at in the vicinity of the target device, and either set parameter data of the target device or environment data concerning the target device, while associating the training time-series data with the set parameter data or the environment data;
dividing the training time-series data into training segments which are pieces of partial time-series data showing an operation state containing both a rise from a first value to a second value and a fall from the second value to the first value in a waveform represented by the training time-series data, to generate a segment set containing the training segments;
classifying the training segments contained in the generated segment set into at least one similar segment set by grouping similar training segments, using either the set parameter data or the environment data;
generating a sample segment showing a normal region of the operation of the target device from the training segments contained in the at least one similar segment set;
collecting test time-series data acquired by a sensor mounted on the monitor target device or disposed at in the vicinity of the monitor target device;
generating a test segment from the test time-series data, the test segment being partial time-series data showing the operation state, and calculating a degree of normality of the test segment by referring to the generated sample segment; and
determining whether or not the monitor target device is defective on a basis of the calculated degree of normality.
